(19) United States
(12) Patent Application Publication
(10) Pub. No.: US 2008/0136355 A1
(43) Pub. Date: Jun. 12, 2008

(54) Backlight driving apparatus for non-emissive display device

(75) Inventors: Sang-Kyoo Han, Seoul (KR); Chung-Wook Roh, Seoul (KR); Sung-Soo Hong, Seoul (KR); Sung-Chin Sakong, Seoul (KR)

Correspondence Address: TROXELL LAW OFFICE PLLC, 5205 LEESBURG PIKE, SUITE 1404, FALLS CHURCH, VA, 22041, US

(73) Assignee: KOOKMIN University Industry-Academic Cooperation Foundation

(21) Appl. No.: 11/723,400

(22) Filed: Mar. 19, 2007

(30) Foreign Application Priority Data
Dec. 7, 2006 (KR) 2006-0123544

(51) Int. Cl. H05B 37/02; H05B 41/39

(52) U.S. Cl. 315/307; 345/102

(57) ABSTRACT

Provided is a backlight driving apparatus for a non-emissive display device which comprises an inverter (or lamp driver) (110) that converts a DC voltage to a preset voltage, a lamp (120) that emits light in response to the input of the converted voltage from the inverter (or lamp driver) (110), a detector (130) that detects electric current or brightness at the lamp, a controller (140) that controls the pulse width of a digital dimming signal in order to provide an adequate control of the electric current or brightness according to a lamp brightness command, a signal generator (150) that generates a signal with fixed frequency and fixed duty ratio for optimizing the operation of the inverter (or lamp driver) (110) and a digital dimmer (160) that generates an inverter driving signal from the logical intersection of the digital dimming signal generated by the controller (140) and the signal generated by the signal generator (150).

### TECHNICAL FIELD

The present invention relates to a backlight driving apparatus for a non-emissive display device that requires backlighting, more particularly to a backlight driving apparatus that switches a driving inverter to optimum fixed duty ratio and fixed frequency, detects the electric current or brightness at a backlight lamp and controls the digital dimming signal applied to the driving inverter for the control of the electric current or brightness of the backlight lamp.

### BACKGROUND ART

Recently, LCD (liquid crystal display) is drawing attention as a non-emissive display device capable of being made lighter and thinner as compared with other display devices. A non-emissive display device such as LCD requires a backlight unit that emits light, which in turn requires an adequate driving apparatus.

FIG. 1a illustrates the construction of the conventional backlight unit driving apparatus for an LCD. FIG. 1b shows the major operation waveform of the inverter (11). And, FIG. 1c shows the waveform of the digital dimming operation.

For the convenience of understanding, a description will be given for an LCD as typical example of non-emissive display devices. However, the backlight driving apparatus of the present invention can be applied to other non-emissive display devices as well.

Referring to FIGS. 1a to 1c, the conventional backlight driving apparatus (10) comprises an inverter (11) that converts a DC input voltage to a preset AC voltage, a lamp (12) that emits light in response to the AC voltage input from the inverter (11), a controller (13) that detects the current input to the lamp (12) and controls the switching of the inverter (11) for the constant control of the detected instantaneous lamp current and instantaneous brightness and a digital dimmer (14) that controls the average brightness of the LCD backlight from outside.

The controller (13) sends a control signal with high fixed frequency and variable duty ratio to the inverter (11) for a constant control of the instantaneous current flown to the lamp (12) in proportion to the brightness of the lamp. In response to the signal, the inverter (11) performs switching of the high fixed frequency and variable duty ratio. Preferably, the high fixed frequency is 60 kHz.

With the digital dimmer (14), a user may set the brightness of the display as he/she wants. The average brightness of the screen is controlled not by a closed loop control but by an open loop control. A lamp brightness command generated by the user's button handling is compared with the digital dimming frequency (in a preferred embodiment, the dimming frequency is 150 Hz) of the sawtooth wave to generate a digital dimming signal, Vdim. Then, a switch driving signal, Vsw, which is obtained from the logical intersection of Vdim and PWM, the output signal of the controller (13), is applied to the inverter (11) to control the brightness. That is, as seen in FIG. 1c, the instantaneous brightness of the lamp is maintained constant all the time since the instantaneous lamp current is closed-loop controlled by the controller (13). And, the average brightness of the screen is open-loop controlled by applying the switch driving signal Vsw, which is obtained from the logical intersection of the digital dimming signal with low frequency and the PWM signal with high frequency, to the inverter (11). If the digital dimming signal is high, the PWM signal is directly applied to the inverter (11) and the lamp emits light. And, if the digital dimming signal is low, the switch driving signal Vsw becomes low and, thus, all the switches (S1-S4) of the inverter (11) are turned off and the lamp is turned out. The turning on and off of the lamp executed by the low-frequency digital dimming signal is imperceivable with human eyes and the average brightness is perceived as if controlled by the duty ratio of the digital dimming signal.

### DISCLOSURE

### Technical Problem

In general, the DC input voltage of the inverter (11) varies between Vin_min and Vin_max. The normal operating point of the inverter (11) shall be determined considering ambient temperature and other disturbance factors. As a rule, the normal DC voltage Vin_norm (Vin_min<Vin_norm<Vin_max) is determined with the duty ratio D of the driving signal of the inverter (11) about 60% of the maximum duty ratio Dmax (D=0.6×Dmax). In this case, the energy of the DC voltage is transferred to the lamp (12) for the duration of 60% of the maximum duty ratio (0.6×Dmax×Ts) through the inverter (11), but is not transferred for the remaining 40% (0.4×Dmax×Ts) and is recycled within the circuit in the form of circulating current. (shaded areas A and B in FIG. 1b) Such a circulating current increases the conduction loss of the inverter (11) and causes the overheating of the apparatus.

Further, since the duty ratio varies for the control of the lamp current, if the duty ratio is low, the current ipri (t3) and ipri (t7) in FIG. 1b becomes small. As a result, zero voltage switching is not occurred at S3 and S2, resulting in switching loss and noise and electromagnetic interference (EMI) problems. In addition, if the duty ratio is low, it is difficult to attain a high brightness and good light efficiency because the fundamental component of the voltage applied to the lamp decreases.

### Technical Solution

In the conventional technology, the instantaneous current of the lamp is closed-loop controlled by the inverter (11) with high fixed frequency and variable duty ratio for a constant control of the instantaneous brightness. And, the average brightness is open-loop controlled by applying the logical intersection of a digital dimming signal generated by the user's button handling with a PWM signal to the controller (13).

In contrast, the present invention relates to a backlight driving apparatus for a non-emissive display device that switches a driving inverter to high fixed duty ratio and fixed frequency for the optimum operation of the inverter and closed-loop controls the digital dimming signal applied to the lamp in order to attain high brightness and efficiency.

The inverter of the present invention is advantageous in that it can operate always at the fixed frequency and fixed duty ratio enabling the optimum operation. That is, the present invention can solve the above-mentioned problems of the conventional technology such as zero voltage switching failure and switching loss caused thereby, noise, electromagnetic interference (EMI), conduction loss and circuit overheating caused by large circulating current, etc. Further, since the fundamental wave component of the lamp input voltage can be maximized, it is possible to attain high brightness and high efficiency.

For this purpose, the backlight driving apparatus for a non-emissive display device of the present invention comprises an inverter (or lamp driver) (110) that converts a DC voltage to a preset voltage, a lamp (120) that emits light in response to the input of the converted voltage from the inverter (or lamp driver) (110), a detector (130) that detects electric current or brightness at the lamp, a controller (140) that controls the pulse width of a digital dimming signal in order to provide an adequate control of the electric current or brightness according to a lamp brightness command, a signal generator (150) that generates a signal with fixed frequency and fixed duty ratio for optimizing the operation of the inverter (or lamp driver) (110) and a digital dimmer (160) that generates an inverter driving signal from the logical intersection of the digital dimming signal generated by the controller (140) and the signal generated by the signal generator (150).

### DESCRIPTION OF DRAWINGS

FIG. 1a illustrates the construction of the conventional backlight unit driving apparatus for an LCD.

FIG. 1b shows the operation waveform of the inverter (11) shown in FIG. 1a.

FIG. 1c shows the waveform of the digital dimming operation.

FIG. 2 illustrates the construction of the backlight driving apparatus for a non-emissive display device according to an embodiment of the present invention.

FIG. 3a shows the circuit diagram for the embodiment shown in FIG. 2.

FIG. 3b shows the operation waveform of the inverter (110) shown in FIG. 3a.

FIG. 3c shows the waveform of the digital dimming operation.

### MODE FOR INVENTION

Hereinafter, the present invention is described in further detail referring to the attached drawings. In the forthcoming description of the present invention, descriptions on the particular known matters deemed to unnecessarily obscure the essential points of the present invention will be omitted.

FIG. 2 illustrates the construction of the backlight driving apparatus for a non-emissive display device according to an embodiment of the present invention.

Referring to FIG. 2, the backlight driving apparatus (100) according to an embodiment of the present invention comprises an inverter (or lamp driver) (110), a lamp (120), a detector (130), a controller (140), a signal generator (150) and a digital dimmer (160).

The inverter (or lamp driver) (110) converts the DC input voltage to a preset voltage, which is applied to the lamp (120). The lamp (120) receives the voltage converted by the inverter (or lamp driver) (110) and emits light.

In general, a transformer is equipped between the inverter (or lamp driver) (110) and the lamp (120) in order to raise the AC output voltage from the inverter (lamp driver) (110) to one adequate for turning the lamp on. But, in an alternative embodiment, the inverter (110) may be directly connected to the lamp (120) without using a transformer. Thus, for the purpose of simplification, a description on the transformer will be omitted.

In the embodiment illustrated in the figure, it is assumed that the lamp (120) is a fluorescent lamp requiring an AC voltage, such as cold-cathode fluorescent lamp (CCFL), external electrode fluorescent lamp (EEFL), flat fluorescent lamp (FFL), etc. In the embodiment illustrated in the figure, the inverter (110) is installed in front of the lamp (120), so that the inverter (110) converts the DC input voltage to the AC voltage and the AC voltage is applied to the fluorescent lamp (120).

However, in an alternative embodiment, a lamp driven by a DC voltage, e.g., LED, may be used instead of the fluorescent lamp. In this case, a DC/DC converter is equipped in front of the lamp (120), instead of the inverter. Accordingly, an inverter or a converter may be installed in front of the lamp (120) depending on situations. In this description, the inverter or converter will be referred to as “lamp driver” or “inverter (or lamp driver)” as a whole.

The detector (130) detects the electric current or brightness of the lamp (120) and transfers it to the controller (140).

The controller (140) receives the electric current or brightness from the detector (130) and compares it with the lamp brightness command from outside to generate an error signal (Vea), which is an amplification of the difference thereof. Then, the error signal is compared with the sawtooth wave of the low dimming frequency to generate a low-frequency PWM signal, which is transferred to the digital dimmer (160). In a preferred embodiment, the dimming frequency is 150 Hz.

The signal generator (150) generates a high-frequency driving signal with optimum fixed frequency and fixed duty ratio for the driving of the inverter (or lamp driver) (110) and transfers it to the digital dimmer (160). In a preferred embodiment, the fixed frequency is 60 kHz.

The digital dimmer (160) transfers the logical intersection of the low-frequency PWM signal received from the controller (140) with the high-frequency driving signal having fixed frequency and fixed duty ratio received from the signal generator (150) to the inverter (or lamp driver) (110).

In an embodiment of the present invention, the present invention controls the average brightness or average current of the lamp rather than the instantaneous brightness or instantaneous current of the lamp. That is, the signal generator (150) generates a high-frequency driving signal with optimum fixed frequency and fixed duty ratio for the optimum driving of the inverter (or lamp driver) (110). However, due to the lack of closed-loop control of the average brightness or average current of the lamp, the average brightness of the lamp tends to vary depending on the change of input voltage or other disturbances, as described above. To solve this problem, the duty ratio of the digital dimming signal, which is applied without further control in the conventional technology, is closed-loop controlled in the present invention depending on the average brightness of the lamp to generate a low-frequency PWM signal. Then, by driving the lamp with the inverter (or lamp driver) (110) through the logical intersection of the PWM signal with the optimum driving signal generated by the signal generator (150), the average brightness and average current can be controlled constant. That is, the present invention employs the pulse count modulation (PCM) technique in which the number of the lamp current pulses of the lamp (120) generated by the high-frequency driving signal having fixed frequency and fixed duty ratio is closed-loop controlled depending on the average brightness or average current.

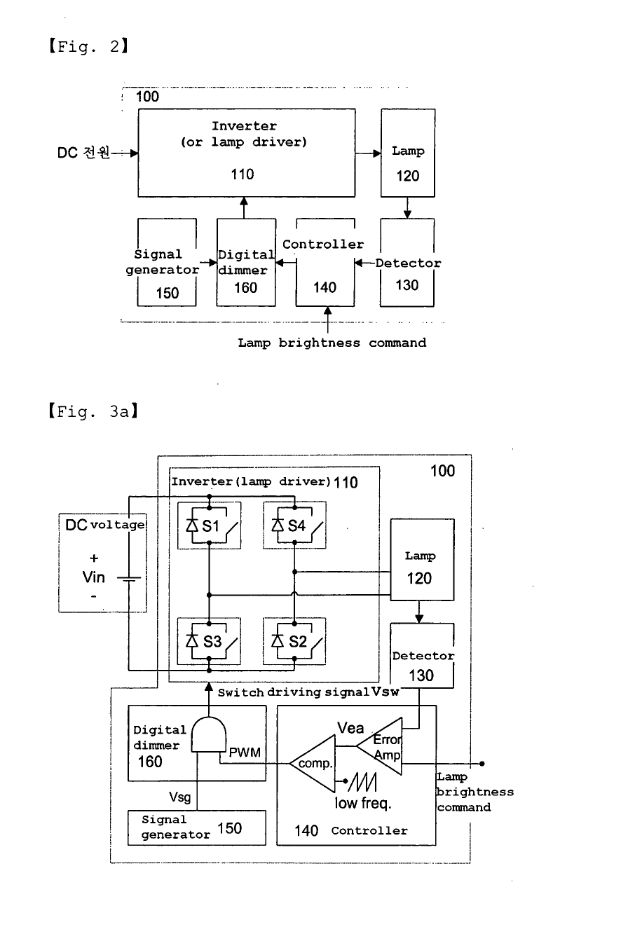

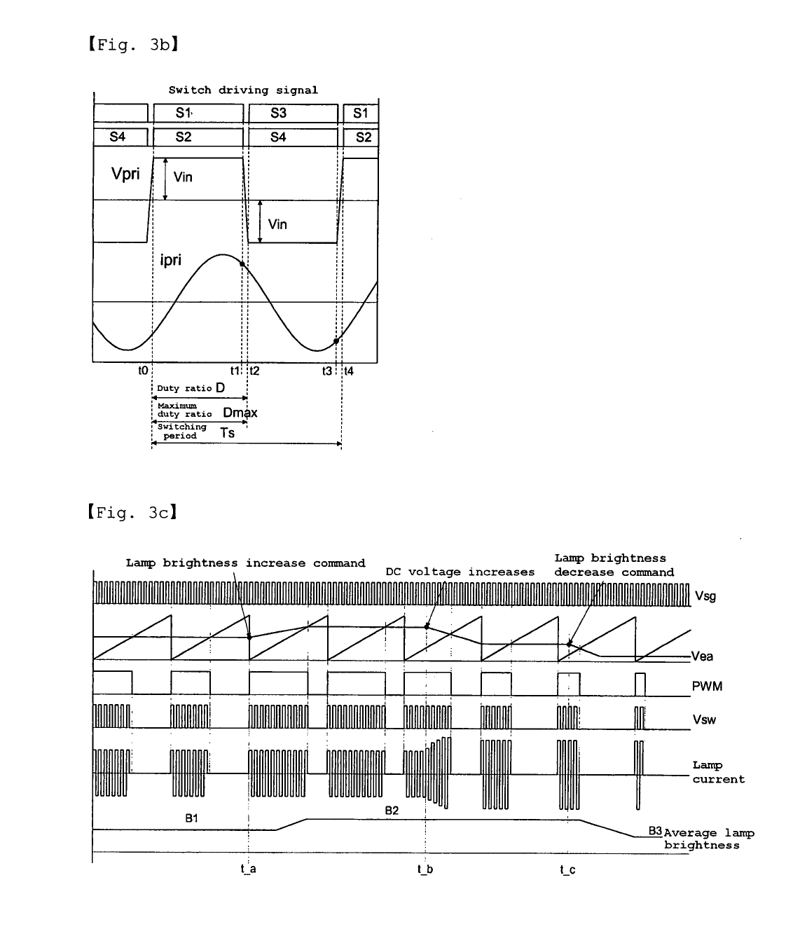

FIG. 3 illustrates a specific embodiment of the one illustrated in FIG. 2. FIG. 3a shows the construction of the backlight unit driving apparatus for a non-emissive display device in accordance with the present invention, FIG. 3b shows the operation waveform of the inverter (110) and FIG. 3c shows the waveform of the digital dimming operation. In this embodiment, the optimum fixed duty ratio D of the signal generator (150) for driving the inverter (or lamp driver) (110) is assumed to be the maximum duty ratio Dmax.

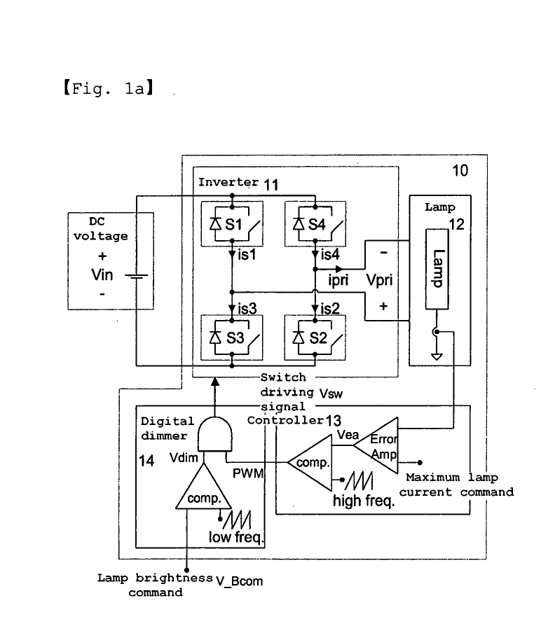

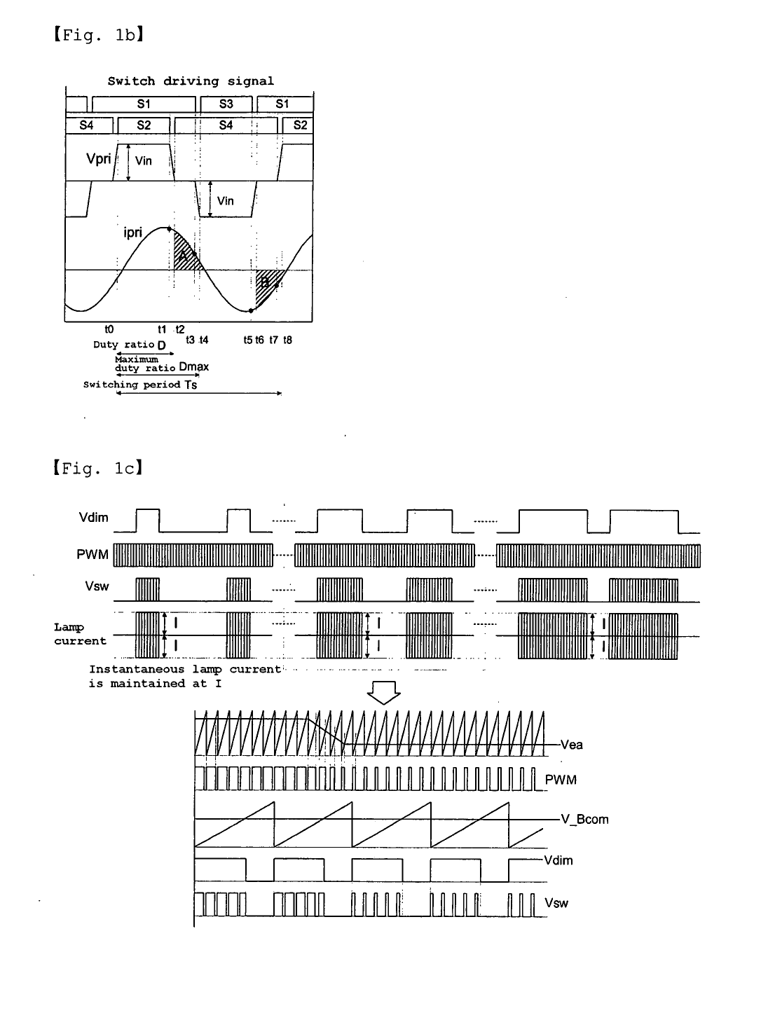

In FIG. 3a, the construction and function of the inverter (lamp driver) (110) and the lamp (120) are the same as those of the inverter (11) and the lamp (12) illustrated in FIG. 1a. That is, a DC voltage is input to the inverter (lamp driver) (110) and converted to a preset AC voltage and the lamp (120) emits light in response to the AC voltage input.

In the embodiment illustrated in FIG. 3a, the inverter (110) is constructed with a full bridge circuit. In other embodiments, the inverter may be constructed with various known inverter circuits. For example, the inverter (110) may be replaced by any inverter circuit known in the related field, including half bridge circuit, push-pull circuit, active clamp forward circuit, etc.

Referring to FIGS. 3a to 3c, the lamp electric current or brightness detected by the detector (130) is compared with the lamp brightness command input by the user's button handling and the difference thereof is amplified by a differential amplifier to obtain the signal Vea, which is transmitted to a comparator to be compared with the low-frequency sawtooth wave of the digital dimming to generate the PWM signal. In turn, the logical intersection of the PWM signal with the high-frequency driving signal Vsg having optimum fixed frequency and fixed duty ratio D (D=Dmax as assumed above) generated by the signal generator (150) is applied to the inverter (or lamp driver) (110). That is, if the PWM signal is high, the Vsw (=Vsg) signal is applied to the inverter (or lamp driver) (110) and the lamp is turned on by the inverter (110). And, if the PWM signal is low, the Vsw signal becomes low and all the switches (S1-S4) of the inverter (or lamp driver) (110) are shut off, thereby turning the lamp off. The brightness of the lamp is controlled in this way.

Referring to FIG. 3c, let's assume that the lamp brightness is maintained at B1 in the steady state. If there is a lamp brightness increase command at time t_a, Vea increases and the number of lamp current pulses also increases. As a result, the lamp average brightness increases to B2 by the PCM action. Suppose that the DC voltage increases abruptly at time t_b due to an external factor. Then, because the lamp current increases, the average current or average brightness of the lamp detected by the detector (130) increases instantaneously and Vea decreases. As a result, the duty ratio of the PWM signal decreases and the number of the lamp current pulses decreases correspondingly. Consequently, the average brightness of the lamp can be controlled constant by the PCM action. If there is a lamp brightness decrease command at time t_c, Vea decreases and the number of lamp current pulses also decreases. As a result, the lamp average brightness decreases to B3 by the PCM action.

FIG. 3b shows the operation waveform of the inverter (or lamp driver) (110) driven by the high-frequency driving signal having optimum fixed frequency and fixed duty ratio D (D=Dmax as assumed above) generated by the signal generator (150) when the PWM signal is high. As seen in FIG. 1b, the conventional method has such problems as zero voltage switching failure and switching loss caused thereby, noise, electromagnetic interference (EMI), conduction loss and circuit overheating caused by large circulating current, etc. because the duty ratio changes. In contrast, the present invention ensures zero voltage switching in all switch operation ranges of the inverter (or lamp driver) (110) because the duty ratio is fixed. Further, since most of the input voltage is directly transmitted as output without circulation, the present invention offers advantages in conduction loss and circuit overheating. Besides, the lamp brightness can be maximized because the fundamental component of the lamp input voltage Vpri becomes largest when D=Dmax.

### INDUSTRIAL APPLICABILITY

In the present invention, the pulse count modulation (PCM) is employed and the frequency and duty ratio of the inverter driving signal are fixed for optimum operation of the inverter (lamp driver). Accordingly, the problems of the conventional inverter, such as zero voltage switching failure and switching loss caused thereby, noise, electromagnetic interference (EMI), conduction loss and circuit overheating caused by large circulating current, etc. resulting from the variation control of the high-frequency driving signal pulse width can be solved. Further, high brightness and efficiency can be attained since the fundamental component of the lamp input voltage can be maximized.

As described, it should be evident that the present invention can be implemented through a variety of configurations in the aforementioned technical field without affecting, influencing or changing the spirit and scope of the present invention. Therefore, it is to be understood that the examples and applications illustrated herein are intended to be in the nature of description rather than of limitation. Furthermore, the meaning, scope and higher conceptual understandings of the present invention as well as modifications and variations that arise therefrom should be understood to be extensions of this invention.

1. A backlight driving apparatus for a non-emissive display device comprising:
a lamp driver (110) that converts a DC voltage to a preset voltage;
a lamp (120) that emits light in response to the input of the converted voltage from the lamp driver (110);
a detector (130) that detects electric current or brightness at the lamp;
a controller (140) that controls the detected electric current or brightness constant according to a lamp brightness command;
a signal generator (150) that generates a driving signal with fixed frequency and fixed duty ratio; and
a digital dimmer (160) that generates an inverter driving signal based on the digital dimming signal generated by the controller (140) and the inverter driving signal generated by the signal generator (150).

2. The backlight driving apparatus as set forth in claim 1, wherein the lamp brightness command is an external signal input by a user's handling of the backlight driving apparatus and the controller (140) generates an error signal (Vea) based on the lamp brightness command and the detected electric current or brightness, which is compared with the sawtooth wave of the low-frequency dimming frequency to generate a digital dimming signal.

3. The backlight driving apparatus as set forth in claim 1, wherein the digital dimmer (160) generates the inverter driving signal from the logical intersection of the digital dimming signal from the controller (140) and the driving signal from the signal generator (150).

4. The backlight driving apparatus as set forth in claim 2, wherein the digital dimmer (160) generates the inverter driving signal from the logical intersection of the digital dimming signal from the controller (140) and the driving signal from the signal generator (150).

5. The backlight driving apparatus as set forth in any of claims 1 to 4, wherein the driving signal having fixed frequency and fixed duty ratio has a frequency higher than that of the digital dimming signal.

6. The backlight driving apparatus as set forth in any of claims 1 to 4, wherein the lamp driver (110) is an inverter that converts an output voltage to an AC voltage and the lamp (120) is one driven by an AC voltage.

7. The backlight driving apparatus as set forth in claim 6, wherein the inverter is constructed with one selected from a full bridge circuit, a half bridge circuit, a push-pull circuit and an active clamp forward circuit and the lamp is one selected from a cold-cathode fluorescent lamp (CCFL), an external electrode fluorescent lamp (EEFL) and a flat fluorescent lamp (FFL).

8. The backlight driving apparatus as set forth in any of claims 1 to 4, wherein the lamp driver (110) is a converter that converts an output voltage to a DC voltage and the lamp (120) is one driven by a DC voltage.
